(19) United States
(12) Patent Application Publication
(10) Pub. No.: US 2003/0008057 A1
(43) Pub. Date: Jan. 9, 2003

(54) Food products

(76) Inventors: Michael P. Hynes, Plymouth, MA (US); Kathryn Kaufman, Jamaica Plain, MA (US); Mark V. Hembling, Sandwich, MA (US)

Correspondence Address: JEFFREY D. HSI, Fish & Richardson P.C., 225 Franklin Street, Boston, MA, 02110-2804, US

(21) Appl. No.: 10/138,592

(22) Filed: Apr. 30, 2002

Related U.S. Application Data
(63) Continuation-in-part of application No. 09/845,417, filed on Apr. 30, 2001.

(51) Int. Cl. C12C 1/00

(52) U.S. Cl. 426/590

(57) ABSTRACT

The invention relates to the discovery of a composition, for example, a beverage, that includes desirable benefits. Such desirable benefits can include, for example, levels of vitamins, minerals, nutrients, factors or compounds that confer healthful benefits, levels of carbohydrate or fiber content, pleasing taste and flavor sensation, pleasing consistency or “mouthfeel”, and lower calorie content. The invention also relates to methods of making the composition and methods of using the composition.

### CROSS-REFERENCE TO RELATED APPLICATIONS

This application claims benefit of U.S. application Ser. No. 09/845,417, filed Apr. 30, 2001, herein incorporated by reference in its entirety.

### TECHNICAL FIELD

This invention relates to food products, particularly beverages, fruit and vegetable juice beverages, and more particularly cranberry juice beverages.

### BACKGROUND

Juices and juice drinks are a source of refreshment for all ages. In addition to their pleasing taste and hydration qualities, juices and juice drinks from various fruits and vegetables also provide additional health benefits. From a nutritional standpoint, juices and juice drinks are a good source of various carbohydrates, vitamins and minerals, as well as other nutrients, factors and compounds that confer health benefits to the consumer. Certain juices or juice extracts or concentrates, however, while having desirable levels of beneficial nutrients, factors and compounds, are also endowed with taste or flavor sensations that are objectionable or unpalatable to certain consumers. In such cases, the taste or flavor sensation of the juice, juice extract or concentrate can be modulated with sweeteners, both natural or artificial, to create a more pleasing taste or flavor sensation, while retaining the healthful levels of nutrients, factors and compounds. Such adjustments, however, typically result in a juice or juice drink that contains substantial levels of sweetener, and thus higher calorie content, or artificial sweeteners. In both instances, these formulations are undesirable to certain consumers.

Examples of typical juice beverages include, for example, OCEAN SPRAY Cranberry Juice Cocktail, OCEAN SPRAY CRANAPPLE Cranberry Apple Juice Drink, OCEAN SPRAY CRAN-RASPBERRY Raspberry Cranberry Juice Drink, and OCEAN SPRAY CRAN-GRAPE Grape Cranberry Juice Drink, and those delineated at the web site www.oceanspray.com. These typical juice beverages have characteristics, for example, sweetness, consistency or mouthfeel, health benefits (e.g., urinary tract health benefits, levels of nutrients, compounds, factors), that are desirable. For example, one cranberry juice drink, OCEAN SPRAY Cranberry Juice Cocktail, contains 27% juice, has a brix value of 13-14, about 25-40 mg of proanthocyanidins (beneficial to urinary tract health) per 8 oz. serving, a brix/acid ratio (BAR) of about 26, about 12-13% by weight high fructose corn syrup, and about 140 calories per 8 ounce serving.

### SUMMARY

The invention relates to compositions, for example, beverages, that include desirable benefits. Such desirable benefits can include, for example, levels of vitamins, minerals, nutrients, factors or compounds that confer healthful benefits, levels of carbohydrate or fiber content, pleasing taste and flavor sensation, pleasing consistency or “mouthfeel”, absence of artificial sweeteners, lower sugar content, and lower calorie content. The invention also relates to methods of making the compositions and methods of using the compositions.

In one embodiment the invention is a composition (e.g., beverage; reduced sugar juice/juice drink; artificial sweetener-devoid reduced sugar juice/juice drink) comprising: sucrose (e.g., cane sugar), fructose (e.g., dry fructose), a hydrocolloid (e.g., pectin, tara gum), and water (e.g., filtered water). In another embodiment, the composition comprises sucrose: fructose: hydrocolloid in a ratio of about 43 to about 55: about 43 to about 55: about 1 to 5, alternatively about 48:48:4, or alternatively about 50:49:1, respectively by weight.

In one embodiment the invention is a composition (e.g., beverage; reduced sugar juice/juice drink; artificial sweetener-devoid reduced sugar juice/juice drink) comprising: sucrose (e.g., cane sugar), fructose (e.g., dry fructose), pectin (e.g., fruit derived pectin, citrus derived pectin, high methoxyl pectin, low methoxyl pectin), and water (e.g., filtered water). In another embodiment, the composition comprises sucrose: fructose: pectin in a ratio of about 43 to about 53: about 43 to about 53: about 3 to 5, alternatively about 48:48:4, respectively by weight.

In alternate embodiments, the compositions are those further comprising one or more juice concentrates, those wherein the juice concentrates are cranberry; apple; raspberry; grape; strawberry; mango; tangerine; black currant; blueberry; peach; pineapple; pear; grapefruit; or a combination thereof, those wherein the juice concentrates are cranberry and one or more of: apple; raspberry; grape; strawberry; mango; tangerine; black currant; or blueberry (e.g., cranberry and apple, cranberry), or those wherein the juice concentrates are apple, pear, raspberry, kiwi, grape, orange, strawberry, lemon, peach, pineapple, passion fruit, mango, cranberry, blueberry, blackberry, or a combination thereof.

In alternate embodiments, the compositions further comprise one or more sweetness enhancers (e.g., natural sweet sugar type flavor).

In alternate embodiments, the compositions further comprise one or more vitamins or vitamin sources (e.g., vitamin C, vitamin A, vitamin E, P-carotene, ascorbic acid).

In alternate embodiments, the compositions further comprise one or more flavor agents (e.g., natural, artificial, berry, cranberry, sweet brown, raspberry, grape, cranberry grape).

In alternate embodiments, the compositions further comprise one or more UTH extracts (e.g., cranberry extract powder, dried cranberry extract powder).

Another embodiment is the composition (e.g., beverage; reduced sugar juice/juice drink; artificial sweetener-devoid reduced sugar juice/juice drink) having proanthocyanidin content between about 10 mg and about 60 mg per 8 oz.; alternatively between about 25 mg and about 45 mg per 8 oz.; alternatively between about 25 mg and about 35 mg per 8 oz.; comprising: sucrose (e.g., cane sugar), fructose (e.g., dry fructose), pectin (e.g., fruit derived pectin, citrus derived pectin, high methoxyl pectin, low methoxyl pectin), UTH extract (e.g., cranberry extract powder, dried cranberry extract powder), and water (e.g., filtered water), wherein the ratio of sucrose: fructose: pectin is about 43 to about 53: about 43 to about 53: about 3 to 5, alternatively about 48:48:4, respectively by weight.

Another embodiment is the composition (e.g., beverage; reduced sugar juice/juice drink; artificial sweetener-devoid reduced sugar juice/juice drink) having proanthocyanidin content between about 10 mg and about 60 mg per 8 oz.; alternatively between about 25 mg and about 45 mg per 8 oz.; alternatively between about 25 mg and about 35 mg per 8 oz.; comprising: sucrose (e.g., cane sugar), fructose (e.g., dry fructose), tara gum, UTH extract (e.g., cranberry extract powder, dried cranberry extract powder), and water (e.g., filtered water), wherein the ratio of sucrose: fructose: tara gum is about 45 to about 55: about 45 to about 55: about 1 to 5, alternatively about 50:49:1, respectively by weight.

In alternate embodiments, the compositions are those further comprising one or more juice concentrates, those wherein the juice concentrates are cranberry, apple, raspberry, grape, strawberry, mango, tangerine, black currant, blueberry, peach, pineapple, pear, grapefruit, or a combination thereof, those wherein the juice concentrates are cranberry and one or more of: apple, raspberry, grape, strawberry, mango, tangerine, black currant, or blueberry, (e.g., cranberry and raspberry, cranberry and apple, cranberry), or those wherein the juice concentrates are apple, pear, raspberry, kiwi, grape, orange, strawberry, lemon, peach, pineapple, passion fruit, mango, cranberry, blueberry, blackberry, or a combination thereof.

In alternate embodiments, the compositions further comprise one or more sweetness enhancers (e.g., natural sweet sugar type flavor).

In alternate embodiments, the compositions further comprise one or more vitamins or vitamin sources (e.g., vitamin C, vitamin A, vitamin E, β-carotene, ascorbic acid).

In alternate embodiments, the compositions further comprise one or more flavor agents (e.g., natural, artificial, berry, cranberry, sweet brown, raspberry, grape, cranberry grape).

In alternate embodiments, the compositions have a brix value of less than about 12, alternatively, of about 8-10.

In another embodiment, the composition comprises cranberry juice (25-30% by weight), sucrose, fructose, pectin, and water, wherein the ratio of sucrose: fructose: pectin is about 43 to about 53: about 43 to about 53: about 3 to 5, respectively by weight, and wherein the composition has a brix value of about 8 to 10, has about 70-120 calories (e.g., about 100-120, about 70-90) calories per 8 ounce serving, has about 25 to 60 milligrams of proanthocyanidins per 8 ounce serving, and is free of artificial sweeteners.

In another embodiment, the composition comprises juice, sucrose, fructose, tara gum, and water, wherein the ratio of sucrose: fructose: tara gum is about 45 to about 55: about 45 to about 55: about 1 to 5, respectively by weight, and wherein the composition has a brix value of about 8 to 10, has about 70-120 calories (e.g., about 100-120, about 70-90) calories per 8 ounce serving, has about 25 to 60 milligrams of proanthocyanidins per 8 ounce serving, and is free of artificial sweeteners.

In another embodiment, the composition comprises cranberry juice (10-20% by weight), sucrose, fructose, pectin, UTH extract, and water, wherein the ratio of sucrose: fructose: pectin is about 43 to about 53: about 43 to about 53: about 3 to 5, respectively by weight, and wherein the composition has a brix value of about 8 to 10, has about 90 calories per 8 ounce serving, has about 25 to 60 milligrams of proanthocyanidins per 8 ounce serving, and is free of artificial sweeteners.

Another embodiment is a method of making a composition (e.g., beverage; reduced sugar juice/juice drink; artificial sweetener-devoid reduced sugar juice/juice drink) comprising combining: sucrose (e.g., cane sugar), fructose (e.g., dry fructose), pectin (e.g., fruit derived pectin, citrus derived pectin, high methoxyl pectin, low methoxyl pectin), and water (e.g., filtered water), wherein the ratio of sucrose: fructose: pectin is about 43 to about 53: about 43 to about 53: about 3 to 5, alternatively about 48:48:4, respectively by weight.

Another embodiment is a method of making a composition (e.g., beverage; reduced sugar juice/juice drink; artificial sweetener-devoid reduced sugar juice/juice drink) comprising combining: sucrose (e.g., cane sugar), fructose (e.g., dry fructose), tara gum, and water (e.g., filtered water), wherein the ratio of sucrose: fructose: tara gum is about 45 to about 55: about 45 to about 55: about 1 to 5, alternatively about 50:49:1, respectively by weight.

Another embodiment is a method of making a composition above further having proanthocyanidin content between about 10 mg and about 60 mg per 8 oz.; alternatively between about 25 mg and about 45 mg per 8 oz.; alternatively between about 25 mg and about 35 mg per 8 oz.; further comprising combining UTH extract (e.g., cranberry extract powder, dried cranberry extract powder).

In alternate embodiments, the methods are those further comprising combining one or more juice concentrates, those wherein the juice concentrates are cranberry, apple, raspberry, grape, strawberry, mango, tangerine, black currant, blueberry, peach, pineapple, pear, grapefruit, or a combination thereof, those wherein the juice concentrates are cranberry and one or more of: apple, raspberry, grape, strawberry, mango, tangerine, black currant, or blueberry (e.g., cranberry and raspberry, cranberry and apple, cranberry), or those wherein the juice concentrates are apple, pear, raspberry, kiwi, grape, orange, strawberry, lemon, peach, pineapple, passion fruit, mango, cranberry, blueberry, blackberry, or a combination thereof.

In alternate embodiments, the methods are those further comprising combining one or more sweetness enhancers (e.g., natural sweet sugar type flavor).

In alternate embodiments, the methods are those further comprising combining one or more vitamins or vitamin sources (e.g., vitamin C, vitamin A, vitamin E, β-carotene, ascorbic acid).

In alternate embodiments, the methods are those further comprising combining one or more flavor agents (e.g., natural, artificial, berry, cranberry, sweet brown, raspberry, grape, cranberry grape).

In alternate embodiments, the compositions have a brix value of less than about 12.

Another embodiment is a composition (e.g., beverage concentrate) comprising: sucrose (e.g., cane sugar), fructose (e.g., dry fructose), pectin (e.g., fruit derived pectin, citrus derived pectin, high methoxyl pectin, low methoxyl pectin), wherein the ratio of sucrose: fructose: pectin is about 43 to about 53: about 43 to about 53: about 3 to 5, alternatively about 48:48:4, respectively by weight. In alternate embodiments, the compositions are those further comprising one or more juice concentrates, those wherein the juice concentrates are cranberry, apple, raspberry, grape, strawberry, mango, tangerine, black currant, blueberry, peach, pineapple, pear, grapefruit, or a combination thereof, those wherein the juice concentrates are cranberry and one or more of: apple, raspberry, grape, strawberry, mango, tangerine, black currant, or blueberry, (e.g., cranberry and raspberry, cranberry and apple, cranberry).

Another embodiment is a composition (e.g., beverage concentrate) comprising: sucrose (e.g., cane sugar), fructose (e.g., dry fructose), tara gum, wherein the ratio of sucrose: fructose: tara gum is about 45 to about 55: about 45 to about 55: about 1 to 5, alternatively about 50:49:1, respectively by weight. In alternate embodiments, the compositions are those further comprising one or more juice concentrates, those wherein the juice concentrates are cranberry, apple, raspberry, grape, strawberry, mango, tangerine, black currant, blueberry, peach, pineapple, pear, grapefruit, or a combination thereof, those wherein the juice concentrates are cranberry and one or more of: apple, raspberry, grape, strawberry, mango, tangerine, black currant, or blueberry, (e.g., cranberry and raspberry, cranberry and apple, cranberry), or those wherein the juice concentrates are apple, pear, raspberry, kiwi, grape, orange, strawberry, lemon, peach, pineapple, passion fruit, mango, cranberry, blueberry, blackberry, or a combination thereof.

In alternate embodiments, the compositions further comprise one or more sweetness enhancers (e.g., natural sweet sugar type flavor).

In alternate embodiments, the compositions further comprise one or more vitamins or vitamin sources (e.g., vitamin C, vitamin A, vitamin E, β-carotene, ascorbic acid).

In alternate embodiments, the compositions further comprise one or more flavor agents (e.g., natural, artificial, berry, cranberry, sweet brown, raspberry, grape, cranberry grape).

In alternate embodiments, the compositions further comprise one or more UTH extracts (e.g., cranberry extract powder, dried cranberry extract powder).

Another embodiment is a method of enhancing urinary tract health in a mammal comprising administration of a composition (e.g., beverage; reduced sugar juice/juice drink; artificial sweetener-devoid reduced sugar juice/juice drink) delineated herein.

Another embodiment is a composition (e.g., beverage; reduced sugar juice/juice drink; artificial sweetener-devoid reduced sugar juice/juice drink made by the process of combining sucrose (e.g., cane sugar), fructose (e.g., dry fructose), pectin (e.g., fruit derived pectin, citrus derived pectin, high methoxyl pectin, low methoxyl pectin), and water (e.g., filtered water), wherein the ratio of sucrose: fructose: pectin is about 43 to about 53: about 43 to about 53: about 3 to 5, alternatively about 48:48:4, respectively by weight. In alternate embodiments, the compositions are those made by further combining one or more juice concentrates, those wherein the juice concentrates are cranberry, apple, raspberry, grape, strawberry, mango, tangerine, black currant, blueberry, peach, pineapple, pear, grapefruit, or a combination thereof, those wherein the juice concentrates are cranberry and one or more of: apple, raspberry, grape, strawberry, mango, tangerine, black currant, or blueberry, (e.g., cranberry and raspberry, cranberry and apple, cranberry).

Another embodiment is a composition (e.g., beverage; reduced sugar juice/juice drink; artificial sweetener-devoid reduced sugar juice/juice drink made by the process of combining sucrose (e.g., cane sugar), fructose (e.g., dry fructose), tara gum, and water (e.g., filtered water), wherein the ratio of sucrose: fructose: tara gum is about 45 to about 55: about 45 to about 55: about 1 to 5, alternatively about 50:49:1, respectively by weight. In alternate embodiments, the compositions are those made by further combining one or more juice concentrates, those wherein the juice concentrates are cranberry, apple, raspberry, grape, strawberry, mango, tangerine, black currant, blueberry, peach, pineapple, pear, grapefruit, or a combination thereof, those wherein the juice concentrates are cranberry and one or more of: apple, raspberry, grape, strawberry, mango, tangerine, black currant, or blueberry, (e.g., cranberry and raspberry, cranberry and apple, cranberry), or those wherein the juice concentrates are apple, pear, raspberry, kiwi, grape, orange, strawberry, lemon, peach, pineapple, passion fruit, mango, cranberry, blueberry, blackberry, or a combination thereof.

In alternate embodiments, the compositions are those made by further combining one or more sweetness enhancers (e.g., natural sweet sugar type flavor).

In alternate embodiments, the compositions are those made by further combining one or more vitamins or vitamin sources (e.g., vitamin C, vitamin A, vitamin E, β-carotene, ascorbic acid).

In alternate embodiments, the compositions are those made by further combining one or more flavor agents (e.g., natural, artificial, berry, cranberry, sweet brown, raspberry, grape, cranberry grape).

In alternate embodiments, the compositions are those made by further combining one or more UTH extracts (e.g., cranberry extract powder, UTH powder).

Another embodiment is process for making a composition comprising selecting a combination of sucrose, fructose, hydrocolloid (e.g., pectin, tara gum) and water, such that the brix value of the composition is about 12 or less (e.g., about 8-10). In alternate embodiments, the processes are those made by further selecting one or more juice concentrates, those wherein the juice concentrates are cranberry, apple, raspberry, grape, strawberry, mango, tangerine, black currant, blueberry, peach, pineapple, pear, grapefruit, or a combination thereof, those wherein the juice concentrates are cranberry and one or more of: apple, raspberry, grape, strawberry, mango, tangerine, black currant, or blueberry, (e.g., cranberry and raspberry, cranberry and apple, cranberry), or those wherein the juice concentrates are apple, pear, raspberry, kiwi, grape, orange, strawberry, lemon, peach, pineapple, passion fruit, mango, cranberry, blueberry, blackberry, or a combination thereof.

In alternate embodiments, the processes are those made by further selecting one or more sweetness enhancers (e.g., natural sweet sugar type flavor).

In alternate embodiments, the processes are those made by further selecting one or more vitamins or vitamin sources (e.g., vitamin C, vitamin A, vitamin E, β-carotene, ascorbic acid).

In alternate embodiments, the processes are those made by further selecting one or more flavor agents (e.g., natural, artificial, berry, cranberry, sweet brown, raspberry, grape, cranberry grape).

In alternate embodiments, the processes are those made by further selecting one or more UTH extracts (e.g., cranberry extract powder, UTH powder).

Another embodiment is a composition comprising 25-30% by weight, cranberry juice; sucrose; fructose; pectin; and water, wherein the ratio of sucrose: fructose: pectin is about 43 to about 53: about 43 to about 53: about 3 to 5, respectively by weight, and wherein the composition has a brix value of 8 to 10, has 100-120 calories per 8 ounce serving, has 25 to 60 milligrams of proanthocyanidins per 8 ounce serving, and is free of artificial sweeteners.

Other embodiments of the invention are any of the compositions delineated herein having between about 5% and about 35% juice content, alternatively between about 10% and about 30% juice content, or alternatively between about 15% and 25% juice content, by weight.

Another embodiment of the invention is a composition comprising sucrose, fructose, and pectin, in a ratio of about 29 to about 68: about 29 to about 68: about 3 to 5, respectively by weight, alternatively about 38 to about 58: about 38 to about 58: about 3 to 5, respectively by weight, alternatively about 43 to about 53: about 43 to about 53: about 3 to 5, respectively by weight, alternatively in a ratio of about 48:48:4, respectively by weight.

Another embodiment of the invention is a composition comprising sucrose, fructose, and tara gum, in a ratio of about 40 to about 60: about 40 to about 60: about 0.5 to 5, respectively by weight, alternatively about 45 to about 55: about 45 to about 55: about 1 to 5, respectively by weight, alternatively about 48 to about 52: about 48 to about 52: about 1 to 2, respectively by weight, alternatively in a ratio of about 50:49:1, respectively by weight.

Another embodiment of the invention is a composition comprising any one or more of the specific ingredients delineated herein, including the Examples below, in any combination, including those combinations specifically delineated herein.

Embodiments of the invention can have one or more of the following advantages. A cranberry juice beverage can be provided that includes cranberry juice in an amount (e.g., 25-30%) commonly found in conventional cranberry juice drinks, but has less sugar and less calories (e.g., 35 to 50% fewer) and is free of artificial sweeteners. Alternatively, this juice beverage can be of juices other than cranberry. The juice beverage utilizes a sucrose/fructose/hydrocolloid (e.g., pectin, tara gum) sweetener, which creates a greater apparent sweetness and also contributes to a desireable body or mouthfeel in spite of a brix level (e.g., 8-10). As a result, the low sugar juice has less sugar and fewer calories without utilizing an artificial sweetener and while providing a full-bodied mouthfeel more characteristic of higher brix, sweeter juice drink.

In embodiments, a cranberry juice drink can be provided that utilizes somewhat lower amounts of cranberry juice, e.g., 10-20%, but includes a cranberry or other UTH extract that provides the levels of nutrients, factors, or compounds (e.g., health benefits, urinary tract health benefits) and flavor of a higher juice content juice drink. The cranberry juice drink can include the sucrose/fructose/hydrocolloid (e.g., pectin, tara gum) sweetener to reduce sugar content (and calories), while providing full-bodied mouthfeel and avoiding artificial sweeteners.

While the techniques are particularly beneficial for preparing low calorie, high body drinks or for food products, utilizing astringent fruits or fruit juices, such as cranberry, in embodiments, the sucrose/fructose/hydrocolloid (e.g., pectin, tara gum) sweetener and UTH extract can be used to sweeten and fortify other food products (e.g., with the health benefit of cranberries), such as e.g., drinks based on other juices, mixed juice drinks, and non-beverage food products, such as dried sweetened cranberries.

In other aspects, the food products (e.g., drinks, beverages) are those delineated herein having essentially no, or are devoid of, diary products (e.g., milk, whey, cream, yogurt), or other products derived from mammalian milk. The food products are also those delineated herein having a hydrocolloid that provides similar body or consistency and flavor as the same food product with higher sugar content and/or no hydrocolloid.

The details of one or more embodiments of the invention are set forth in the description below. Other features, objects, and advantages of the invention will be apparent from the description and from the claims.

### DETAILED DESCRIPTION

A cranberry food product includes a sweetener composition having sucrose, fructose, and pectin. The food product can also have a cranberry extract. The sweetener composition can be utilized in a food product, e.g., a beverage, including a flavoring, such as a cranberry juice fruit, or other fruit, flavoring. An alternate example is a cranberry fruit beverage that includes an amount of cranberry juice, cranberry extract, or cranberry flavoring consistent with the health benefits and taste of conventionally sugar-sweetened cranberry juice cocktail, but has fewer calories and does not contain artificial sweeteners.

The sucrose adds sweetness and, it is believed, works synergistically with the fructose to enhance the apparent or perceived sweetness. The sucrose lends the compositions sweetness over time after consumption, with slower dissipation of sweetness than fructose. The term “sucrose” refers to a water soluble sugar obtained from sugarcane, sugar beets, sorghum, maple sugar, and the like. Sucroses can be solid or liquid in form including, for example, sucrose, cane sugar, beet sugar, medium invert, and the like. Sucroses can also be in the form of a syrup or a saturated aqueous solution (e.g., ca. 68%). A specific sucrose useful in the compositions is cane sugar, available from A. E. Staley Manufacturing Company, Decatur, Ill.

The fructose adds sweetness and, it is believed, works synergistically with the sucrose to enhance the apparent or perceived sweetness. The fructose lends the compositions sweetness immediately upon consumption, with faster dissipation of sweetness than sucrose. The term fructose refers to a fruit sugar. Fructoses are extremely sweet and a natural by-product of fruits, honey, plants, and vegetables. Fructose can be solid or liquid in form including, for example, granular fructose (e.g., dry KRYSTAR, A. E. Staley Manufacturing Company, Decatur, Ill.) and liquid fructose (e.g., high fructose corn syrup).

The combination of sucrose and fructose results in a sweetness synergy that contributes an overall sweetness to the compositions, both immediate and of longer duration upon consumption of the composition. This effect is not achieved by sucrose or fructose individually. Sucroses and fructoses can be in various solid forms, including crystal, granulated, and powdered, or may be a sugar blend (e.g., brown sugar).

The pectin is a water-soluble carbohydrate, present in various fruits and vegetables. It is believed that the pectin contributes to a desirable, naturally sweetened mouthfeel and consistency, or viscosity, of food products utilizing the sweetener compositions herein. Pectins useful in the compositions include both high methoxyl pectins and low methoxyl pectins. Beverage compositions can contain high methoxyl pectins (e.g., citrus-derived pectins, apple derived pectins). Sauce or gel compositions can contain low methoxyl pectins. A specific example of a pectin useful in the compositions is Pectin HM, available from C P Kelco, Wilmington, Del.

The pectin is a hydrocolloid that provides the beverage with a certain resting viscosity. Other hydrocolloids that can be used in place include acacia gum, agar, guar gum, karaya gum, tara gum, locust bean gum, tragacanth gum, cellulose gum, carrageenan, starches and gelatin. The beverages typically contain about 0.001% to about 4.0%, alternatively about 0.1% to about 2.0%, or 0.5% to about 1.0%, of the hydrocolloid by weight. Shear thinning gums are substances that exhibit pseudoplastic behavior. They can be used in the beverages to provide suitable resting viscosities and apparent viscosities. Shear thinning gums include alginates, xanthan gum, gellan gum, cellulose gum (e.g., carboxymethylcellulose), and konjac flour.

The tara gum is available from a variety of commercial sources, including for example, Degussa, Inc., Atlanta Ga. The tara gum can be used as a blend (e.g., with dextrose), which enhances handling properties, such as for example, consistency and viscosity. A commercial product, NUSCOPE D, available form Degussa, is one example of such a blend. The tara gum may also be in the form of a combination of one or more gums delineated herein, including those combinations wherein tara is the predominate gum in the combination.

The sucrose, fructose, and hydrocolloid (e.g., pectin, tara gum) combination provides a sweetener composition that has a high apparent or perceived sweetness and natural mouthfeel. The sucrose/fructose/pectin combination is present in a ratio of, e.g., about 29 to about 68: about 29 to about 68: about 3 to 5, respectively by weight, alternatively about 38 to about 58: about 38 to about 58: about 3 to 5, respectively by weight, alternatively about 43 to about 53: about 43 to about 53: about 3 to 5, respectively by weight. A specific ratio is about 48:48:4, respectively by weight. The sucrose/fructose/tara gum combination is present in a ratio of, e.g., about 40 to about 60: about 40 to about 60: about 0.5 to 5, respectively by weight, alternatively about 45 to about 55: about 45 to about 55: about 1 to 5, respectively by weight, alternatively about 45 to about 55: about 45 to about 55: about 1 to 2, respectively by weight. A specific ratio is about 50:49:1, respectively by weight.

Further, the sucrose, fructose, hydrocolloid (e.g., pectin, tara gum), and flavoring agent (e.g., one or a combination of flavoring agents) combination provides a sweetener composition that has a high apparent or perceived sweetness and natural mouthfeel. This combination has a distinguishable sweetness (apparent or perceived) characteristic. This sweetness is derived from a synergy of the sucrose, fructose and flavoring agent, and is synergistically enhanced by the presence of the hydrocolloid (e.g., pectin, tara gum).

The sweetness of a composition may be measured on the relative sweetness (“RS”) scale (See, for example, KRYSTAR Technical Data Sheet No. 793040, A. E. Staley Manufacturing Company, Decatur, Ill.). According to this scale, based on 10% dissolved solids aqueous solution at room temperature, sucrose has a RS of 100 while fructose has a RS of 117. Fructose in its crystalline form, however, has an RS of 180. In alternate embodiments, the sucrose/fructose/pectin sweetener compositions have a sweetness measurement of e.g., about 100 to about 150, alternatively of about 110 to about 140, alternatively of about 120 to about 130.

One measure of sugar content is the “brix” value, a measure of the percentage of dissolved soluble solids (e.g., sugar) in a solution. For example, in the typical cranberry juice cocktail, the sugar content is a brix value of around 13-14. In embodiments, the compositions delineated herein have a lower sugar content than a typical juice beverage and thus a lower brix value. The compositions delineated herein can have a brix value of less than about 12, alternatively less than about 10, or alternatively between about 8 and about 10.

Beverage compositions can also be characterized by their brix/acid ratio (“BAR”), which is the ratio of the brix value of the beverage divided by the percent acid content. For example, in a typical cranberry juice drink, the BAR is e.g., about 21 to about 28. In the compositions including the sweetener composition and cranberry juice/juice concentrate (e.g., cranberry, cranberry raspberry, cranberry apple), the BAR is e.g., about 21 to about 28. In a typical grape juice drink, the BAR is e.g., about 28 to about 36. In embodiments, the compositions including the sweetener composition and grape juice/juice concentrate and no cranberry, the BAR is e.g., about 19 to about 33, about 21 to about 28, about 21 to about 31.

The sweetener compositions provide certain benefits for cranberry food products, such as beverages. A specific example of a beverage is one having about 5-10%, alternatively about 7%, by weight of the sweetener composition. An alternate specific example is a cranberry beverage having about 5-10%, alternatively about 7%, by weight of the sweetener composition.

As described above, typical cranberry juice drink contains about 25-30% cranberry juice by weight. This proportion of juice is desirable in that the level of certain factors or compounds, including for example, proanthocyanidins, is such that urinary tract health is enhanced by ingestion of these factors or compounds (See, for example, A. B. Howell, et al., Inhibition of the Adherence of P-Fimbriated Escherichia coli to Uroepithelial-Cell Surfaces by Proanthocyanidin Extracts from Cranberries, New England Journal of Medicine, Vol. 339, No. 15, (1998), and references cited therein, all incorporated by reference in their entirety). Cranberry juice can have a sour or bitter taste, however, particularly at such levels. To counteract these attributes, significant amounts of a sweetener, typically sugar, is added to make the beverage more palatable. Alternatively, an artificial sweetener (e.g., aspartame, saccharin, acesulfame-K, sucralose) or a sugar alcohol (e.g., sorbitol, xylitol, mannitol) may be added. In either case, certain consumers while desiring the healthful benefits of typical cranberry juice drink, are put-off by the amount of sugar (and inherent calories) or the presence of artificial sweetener in the beverage.

In embodiments, these issues are addressed by providing a combination of ingredients that provide a pleasant tasting, yet reduced sugar (e.g., reduced calorie) beverage. The compositions have the sensory impact (e.g., consistency, mouthfeel, texture, taste, sweetness) that appeals to consumers, including those consumers of a typical, or higher calorie, juice beverage. Such sensory impact can be assessed in a variety of ways, including, for example, taste testing panels, where subjects are provided samples to taste and then provide commentary, either orally (direct questioning) or in writing (e.g., questionnaire) on their reaction to the tasting. The compositions can also provide a beverage that is lower in calories than a typical or higher calorie version of the same beverage, but has a sweetness level, as measured by standardized sweetness measurement testing (e.g., as described in KRYSTAR Technical Data Sheet No. 793040, A. E. Staley Manufacturing Company, Decatur, Ill.), essentially similar to the typical or higher calorie version of the beverage. The beverage can have a juice content similar to that of conventional juice drinks, but with lower calories. The beverage can also have a lower astringent juice content (e.g., cranberry), or lower overall juice content than conventional drinks, and lower calories. The reduced sugar beverages delineated herein typically have between about 35 to about 50% less calories, alternatively between about 40 to about 45% less calories, or alternatively about 40% less calories than the corresponding typical or higher calorie version.

In embodiments, the beverage or other food product can include a UTH extract. A “UTH extract” is an extract having nutrients, factors, or compounds therein that enhance or impart a beneficial effect on health, including urinary tract health. Such extracts can include, for example, proanthocyanidin compounds, anthocyanidin compounds, proanthocyanin compounds, anthocyanin compounds, fruit extracts (e.g., berry, cranberry, blueberry, blackberry, grape, raspberry), cranberry extract powder (e.g., dried cranberry extract powder, Ocean Spray Cranberries, Inc., Lakeville Mass.; 90MX Powder, Ocean Spray Cranberries, Inc.), and vegetable extracts. Additionally, fruit and vegetable extracts such as those described in U.S. patent application Ser. No. 09/611,852, (filed Jul. 7, 2000) can be used in the compositions delineated herein. The health benefits of the aforementioned nutrients, factors, compounds and extracts are known in the art (See, for example, Nutraceuticals: The Complete Encyclopedia of Supplements, Herbs, Vitamins, and Healing Foods, A. J. Roberts, M. E. O'Brien, and G. Subak-Sharpe, eds., American Nutraceutical Association, Birmingham, Ala. (2001)). The urinary tract health benefit of nutrients, factors, compounds and extracts can be derived from berries, including blackberries, blueberries, and cranberries (See, for example, A. B. Howell, et al., Inhibition of the Adherence of P-Fimbriated Escherichia coli to Uroepithelial-Cell Surfaces by Proanthocyanidin Extracts from Cranberries, New England Journal of Medicine, Vol. 339, No. 15, (1998), and references cited therein, all incorporated by reference in their entirety).

One benefit is a reduced sugar cranberry juice beverage (e.g., cranberry, cranberry raspberry, cranberry apple) having the sweetener composition and UTH extract. The combination of the sweetener composition and lower levels of cranberry juice (or cranberry juice concentrate) (e.g., about 27% cranberry in typical cranberry juice drink compared to about 10-20%, e.g., about 12-16%, in a reduced sugar cranberry juice drink) result in a beverage having less total sugar, and thus less calories per serving. At the same time, the urinary health benefit (e.g., proanthocyanidin content) is retained in the reduced sugar juice drink relative to a typical juice drink. Thus, the combination of sweetener composition, UTH extract and cranberry juice/juice concentrate give a pleasant tasting, palatable juice drink that is lower in calories and has similar health benefits (e.g., urinary tract health benefits) relative to a typical cranberry juice drink.

Further, the compositions provide a beverage having essentially the health benefits of a typical juice drink (e.g., cranberry, grape), yet are lower in calorie content than a typical juice drink (e.g., cranberry, grape). The health benefits of the compositions delineated herein include those benefits from nutrients, factors or compounds of fruits, vegetables, extracts thereof, or their juice, and include, for example, proanthocyanidin compounds, anthocyanidin compounds, proanthocyanin compounds, anthocyanin compounds, phytochemicals, cranberry extracts and grape extracts. Such health benefits include, for example, enhancement of urinary tract health, bacterial anti-adhesion properties, cardiovascular benefits, benefits from antioxidants, lower cholesterol, and anti-cancer. As such, alternate embodiments of the invention are nutraceutical products including any of the compositions delineated herein.

For example, a conventional cranberry juice drink (e.g., 25-30% juice) contains !=between about 25 and about 60 milligrams of proanthocyanidins per eight ounces of beverage, and thus confers health benefits based in part thereon. In embodiments, compositions while lower in calories than the typical cranberry juice beverage, have an essentially similar level of proanthocyanidins relative to the typical or higher calorie version. In embodiments, compositions have between about 10 and about 60 milligrams of proanthocyanidins per eight ounces of beverage, alternatively between about 25 and about 45 milligrams of proanthocyanidins per eight ounces of beverage, alternatively between about 25 and about 35 milligrams of proanthocyanidins per eight ounces of beverage.

The compositions and methods, and the extracts referred to herein, can include any desired fruit or vegetable or combination thereof, for example, cranberries, blueberries, bilberries, blackberries, currants, raspberries, strawberries, cherries, grapes, apples, peaches, pears, mangos, kiwis, guavas, oranges, grapefruits, lemons, limes, prunes, lingonberries, melons, apricots, and nectarines, carrots, celery, lettuce, wheatgrass, kale, broccoli, beans, cauliflower, cucumbers, squash, turnips, potatoes, yams, and beets.

Juice concentrates used in the compositions may be of fruit or vegetable origin including, for example, cranberry, apple, raspberry, grape, strawberry, cherry, mango, tangerine, black currant, peach, pear, pineapple, grapefruit, kiwi, lemon, orange, passion fruit, blueberry, blackberry, and the like. Juice concentrates may be used singly or on combination. Sources of juice concentrates include, for example, Naumes Concentrates, Wapato, Wash.; Valley Concentrates, San Juanquin, Calif.; and Milne, Prosser, Wash.

The water used in the compositions can be filtered (e.g., charcoal, reverse osmosis) or deionized. The water may be non-carbonated or carbonated.

A “reduced sugar” beverage is a beverage having less sugar than its higher sugar counterpart and attempting to achieve essentially the same or similar sensory impact (e.g., taste, sweetness, consistency, mouthfeel). A reduced sugar beverage has fewer calories than the same beverage having essentially an equally sweet and acceptable taste. A reduced sugar beverage (e.g., cranberry juice containing beverage, grape juice containing beverage) can have essentially the same or similar brix/acid ratio (BAR) as a typical cranberry juice beverage. A reduced sugar beverage (e.g., cranberry juice containing beverage, grape juice containing beverage) having a UTH extract can have essentially the same or similar urinary tract health benefit, or has essentially the same or similar levels of nutrients, factors, or compounds as the typical cranberry juice beverage.

A “concentrate” is a concentrated form of the material at issue.

The food product can also include other ingredients, for example, flavor agents, sweetness enhancers, vitamins, and acidic agents. A “flavor agent” is an ingredient that imparts a flavor. The flavor agent may be a natural or an artificial flavor. The flavor agent may be made of a single flavor or a plurality of individual flavors combined. The flavor agents can be combined in the compositions delineated herein singly, in combination, or as a premixed combination. The flavor agents can be fruit or vegetable flavor, or other more general food and beverage flavoring agents (e.g., sweet flavor). Flavor agents include, for example, grape, cranberry, raspberry, berry, strawberry, blueberry, kiwi, mango, sweet brown type, and sweet sugar type. Flavor agents include, for example, grape flavor package (Ocean Spray Cranberries, Inc. Lakeville, Mass., No. 2087000), natural cranberry type flavor (Robertet Flavors, Piscataway, N.J., NV-24,814), raspberry flavor (wonf) (Robertet Flavors, Piscataway, N.J., NV-20,977), raspberry essence blend (Ocean Spray Cranberries, Inc. Lakeville, Mass., No. 20909000), berry flavor (wonf) (Haarmann & Reimer, Teterboro, N.J., No. 814291), cranberry grape flavor blend (Dragoco Inc. Totawa, N.J., No. 9/70p613), strawberry flavor (wonf), (Robertet Flavors, Piscataway, N.J., NV-15,982), natural blueberry flavor (wonf), (Dragoco Inc. Totawa, N.J., 9/70F383), natural raspberry flavor (wonf) (Robertet Flavors, Piscataway, N.J., NV-27,007), raspberry flavor (wonf) (Robertet Flavors, Piscataway, N.J., NV-27,004), and the like . The term “wonf” is a designation known in the art for “with other natural flavors”.

A “sweetness enhancer” is an ingredient that enhances the sweetness of the mixture it is combined with. Such ingredients may be natural or artificial. Examples of sweetness enhancers include natural sweet sugar type flavor (Takasago International Corp. Rockleigh, N.C., No. 001757), natural sweet extender (Firmenich, Princeton, N.J., No. 557127 S), and sweet brown type flavor blend (Dragoco Inc. Totawa, N.J., No. 9/70n564) and the like.

A “vitamin” or “vitamin source” is a vitamin, including its derivative forms (e.g., salts) or an entity that can undergo transformation under typical metabolic conditions (e.g, upon ingestion and entry into or passage through the digestive system) to the vitamin. Vitamins, include for example, vitamin C, ascorbic acid, vitamin A, vitamin E, β-carotene, and the like.

The compositions can also include acidic agents. Acid agents are useful to enhance taste (apparent or perceived) or mouthfeel (e.g., consistency, viscosity) characteristics to the compositions. Acidic agents include, for example, fumaric acid, citric acid, malic acid, and the like.

The acidity, or pH level, of the compositions delineated herein is another physical characteristic that can affect the shelf-life as well as the taste and mouthfeel of the compositions as described above. In one aspect, the compositions herein can have a pH range of about 2.5-4.0 (e.g., 3.0-3.5). In another aspect, the compositions herein are those having pH in the range of about 3.1 to about 3.4, which retain their sweetness and flavor for a longer time than compositions with lower (i.e., more acidic) pH. This is due, in part, to the faster breakdown of the sugars at lower (e.g., pH 2, or more acidic) pH.

The ingredients that can be used in the compositions and methods delineated herein are readily available from various commercial sources. Additionally, another embodiment of the invention relates to any of the compositions delineated herein further comprising other additives (e.g., colors, coloring agents, preservatives) that enhance the characteristics, (e.g., physical, commercial appeal) of the compositions.

In other embodiments, such as foods, beverages, confections, and nutritional and therapeutic products comprising the compositions delineated herein. For example, the compositions delineated herein may be prepared in the form of beverages (e.g., juice drinks, flavorings, smoothies (See, for example, U.S. patent application Ser. No. 09/393,175, filed Sep. 9, 1999), confections (e.g., ice pops, candy, jams, jellies, lozenges), sauces (gelatins, dressings, spreads), as well as concentrates for later dilution into beverages for consumption (e.g., frozen, liquids (aseptically packaged, canned)). Another example is a cranberry such as described in U.S. Pat. No. 5,419,251, which has been modified by infusion of a flavoring. The compositions delineated herein can also be used as part of a delivery system for pharmaceuticals, nutritional additives, and other ingestible products.

The methods of preparing the compositions delineated herein can utilize standard apparatuses, conditions and protocols known in the art. Mixing vessels can be made of any suitable material (e.g., stainless steel, glass). The vessels may include an agitation mechanism, (e.g., stirrer, paddle, jet spray, shaker) that is part of the vessel or separate, either in direct contact with the mixture or such that the vessel itself is in motion, thus imparting a mixing effect on the contents. In the methods herein, the order of addition of any ingredient or combinations of ingredients can be varied. Ingredients in dry form may be added dry, or alternatively as a solution in an appropriate liquid.

All references cited herein, whether in print, electronic, computer readable storage media or other form, are expressly incorporated by reference in their entirety, including but not limited to, abstracts, articles, journals, publications, texts, treatises, technical data sheets, internet web sites, databases, patents, patent applications, and patent publications.

Embodiments are further described in the following representative examples, which do not limit the scope of the invention described in the claims.

### EXAMPLES

### Preparation of a Fruit Beverage

Pectin (2.086 lb.), sucrose (28.601 lbs.), and fructose (28.503 lbs.) are combined in a mixing vessel equipped with a suitable agitation mechanism. Ascorbic acid (0.360 lbs.) and Dried cranberry extract powder (1.080 lbs.) are then combined in the mix with further agitation. The resulting mixture is then added to water (770.932 lbs.) in a suitable mixing vessel with moderate agitation. To this mixture is then added cranberry juice concentrate (19.281 lbs.) and apple juice concentrate (7.152 lbs.). After sufficient mixing, cranberry flavor (0.835 lbs.), berry flavor (0.071 lbs.), and natural sweet sugar type flavor (0.594 lbs.) are added to the mixture, and this mixture is agitated for an appropriate period of time. Amounts recited are in pounds, wet weight.

The following juice beverages were prepared essentially in the manner described above using the ingredients as delineated respectively. In these examples, BAR is the brix/acid ratio, calories are per 8 oz. serving, and proanthocyanidin content (PAC) is mg per 8 oz. serving.

Grape Juice Cocktail
(30% fruit juice, 90 calories, brix = 9.2, BAR = 32.8)

| Ingredient | Wet Weight (lbs) |
|---|---|
| Sucrose | 17.469 |
| Fructose | 17.000 |
| Pectin | 1.250 |
| Concord Grape Concentrate | 41.722 |
| Red Grape Concentrate | 21.364 |
| Cranberry-Grape flavor | 0.840 |
| Grape Flavor | 0.737 |
| Sweet Brown Type Flavor | 0.192 |
| Ascorbic Acid | 0.360 |
| Fumaric Acid | 0.600* |
| Water | 759.664 |

*Fumaric added in amount to adjust titratable acidity to 0.28

Cranberry Juice Cocktail
(20% fruit juice, 90 calories, PAC = 25-40, brix = 8.7, BAR = 24.8)

| Ingredient | Wet Weight (lbs) |
|---|---|
| Sucrose | 28.601 |
| Fructose | 28.503 |
| Pectin | 2.086 |
| Cranberry Concentrate | 19.281 |
| Apple Concentrate | 7.152 |
| Dried cranberry extract powder | 1.080 |
| Cranberry Flavor | 0.835 |
| Nat. Sweet Sugar Type Flavor | 0.694 |
| Ascorbic acid | 0.360 |
| Berry Flavor | 0.071 |
| Water | 770.932 |

Cranberry-Raspberry Juice Cocktail
(20% fruit juice, 90 calories, PAC = 25-40, brix = 9.2, BAR = 24.9)

| Ingredient | Wet Weight (lbs) |
|---|---|
| Sucrose | 28.731 |
| Fructose | 28.559 |
| Pectin | 1.669 |
| Cranberry Concentrate | 19.281 |
| Apple Concentrate | 4.291 |
| Raspberry Concentrate | 2.442 |
| Dried cranberry extract powder | 1.077 |
| Natural Cranberry Flavor | 2.604 |
| Natural Raspberry flavor | 0.881 |
| Raspberry Essence Blend | 0.835 |
| Nat. Sweet Sugar Type Flavor | 0.447 |
| Ascorbic acid | 0.360 |
| Berry Flavor | 0.071 |
| Water | 768.296 |

Strawberry-Kiwi Juice Cocktail
(% fruit juice = 20, calories = 80, brix = 8.1, BAR = 20.8)

| Ingredient | Wet Weight (lbs) |
|---|---|
| Sucrose | 23.119 |
| Dry Krystar | 22.002 |
| Kiwi Concentrate | 11.630 |
| Grape Concentrate | 11.369 |
| Orange Concentrate | 5.103 |
| Strawberry Concentrate | 4.533 |
| Lemon Concentrate | 3.578 |
| Natural Strawberry Kiwi flavor | 3.176 |
| Citric Acid | 0.700 |
| Sodium Citrate | 0.650 |
| Tara Gum Powder NUSCOPE D | 0.400 |
| Ascorbic Acid | 0.360 |
| Red Liquid Color | 0.070 |
| Water | 770.699 |

Grape Juice Cocktail
(% fruit juice = 30, calories = 90, brix = 9.2, BAR = 30.7)

| Ingredient | Wet Weight (lbs) |
|---|---|
| Sucrose | 17.728 |
| Grape Concentrate | 41.722 |
| Red Grape Concentrate | 20.861 |
| Dry Krystar | 17.000 |
| Grape Flavor WONF | 1.769 |
| Fumaric Acid | 0.900 |
| Sodium Citrate | 0.700 |
| Tara Gum Nuscope | 0.400 |
| Ascorbic Acid | 0.360 |
| Water | 759.874 |

Tropical Blend Juice Cocktail
(% fruit juice = 20, calories = 80, brix = 8.4, BAR = 21.5)

| Ingredient | Wet Weight (lbs) |
|---|---|
| Sucrose | 24.908 |
| Orange Concentrate | 19.137 |
| NN-Peach Puree Concentrate | 5.691 |
| Dry Krystar | 24.000 |
| Pineapple Concentrate | 5.510 |
| Passion Fruit Concentrate | 4.925 |
| Mango Concentrate | 3.796 |
| Citric Acid | 1.450 |
| Tara Gum Powder NUSCOPE D | 0.400 |
| Nat. Mango Flv. | 0.379 |
| Ascorbic Acid | 0.360 |
| Red Liquid Color | 0.033 |
| Water | 767.818 |

Cranberry-Wildberry Juice Cocktail
(% fruit juice = 20, calories = 80, PAC = 5-10, brix = 8.4,
BAR = 21.5)

| Ingredient | Wet Weight (lbs) |
|---|---|
| Sucrose | 24.195 |
| Red Grape Concentrate | 22.947 |
| Cranberry Concentrate | 7.712 |
| Dry Krystar | 23.600 |
| Blueberry Juice Concentrate | 1.331 |
| Blackberry Concentrate | 1.331 |
| Sodium Citrate | 1.250 |
| Citric Acid | 1.300 |
| Raspberry Concentrate | 1.221 |
| Strawberry Flv. WONF NV-15,982 | 1.053 |
| Natural Blueberry WONF 9/70F383 | 0.993 |
| Nat. Raspberry Flv. WONF NV-27,007 | 0.648 |
| Nat. Raspberry Flv. WONF NV-27,007 | 0.648 |
| Nat Sweet Extender | 0.439 |
| Tara Gum Nuscope | 0.400 |
| Ascorbic Acid | 0.360 |
| Water | 769.538 |

It is to be understood that while the invention has been described in conjunction with the detailed description, the foregoing description is intended to illustrate and not limit the scope of the invention, which is defined by the scope of the appended claims. All of the features disclosed herein may be combined in any combination. Accordingly, other aspects, advantages, and modifications are within the scope of the following claims.

What is claimed is:

1. A composition comprising:
(1) sucrose;
(2) fructose;
(3) tara gum; and
(4) water,
wherein the ratio of sucrose: fructose: tara gum is about 45 to about 55: about 45 to about 55: about 1 to 5, respectively by weight.

2. The composition of claim 1, further comprising one or more flavor agents.

3. The composition of claim 2, further comprising one or more juice concentrates.

4. The composition of claim 3, further comprising one or more vitamins or vitamin sources.

5. A composition comprising:
(1) sucrose;
(2) fructose; and
(3) tara gum,
wherein the ratio of sucrose: fructose: tara gum is about 45 to about 55: about 45 to about 55: about 1 to 5, respectively by weight.

6. The composition of claim 5, further comprising one or more flavor agents.

7. The composition of claim 6, further comprising one or more juice concentrates.

8. The composition of claim 7, further comprising one or more vitamins or vitamin sources.

9. The composition of any of claims 5-8, further comprising one or more sweetness enhancers.

10. A composition comprising:
(1) 25-30% by weight, cranberry juice;
(2) sucrose;
(3) fructose;
(4) tara gum; and
(5) water,
wherein the ratio of sucrose: fructose: tara gum is about 45 to about 55: about 45 to about 55: about 1 to 5, respectively by weight, and wherein the composition has a brix value of 8 to 10, has 100-120 calories per 8 ounce serving, has 25 to 60 milligrams of proanthocyanidins per 8 ounce serving, and is free of artificial sweeteners.

11. The composition of any of claims 1-4, further comprising UTH extract.

12. A composition comprising:
(1) sucrose;
(2) fructose;
(3) tara gum;
(4) UTH extract; and
(5) water.

13. A composition having proanthocyanidin content between about 10 mg and about 60 mg per 8 oz. comprising:
(1) sucrose;
(2) fructose;
(3) tara gum;
(4) UTH extract; and
(5) water,
wherein the ratio of sucrose: fructose: tara gum is about 45 to about 55: about 45 to about 55: about 1 to 5, respectively by weight.

14. The composition of claim 13, further comprising one or more flavor agents.

15. The composition of claim 14, further comprising one or more juice concentrates.

16. The composition of claim 15, further comprising one or more vitamins or vitamin sources.

17. A method of making a composition comprising combining:
(1) sucrose;
(2) fructose;
(3) tara gum;
(4) UTH extract; and
(5) water,
wherein the ratio of sucrose: fructose: pectin is about 45 to about 55: about 45 to about 55: about 1 to 5, respectively by weight.

18. The method of claim 17, further comprising combining one or more flavor agents.

19. The method of claim 18 further comprising combining one or more juice concentrates.

20. The method of claim 19, further comprising combining one or more vitamins or vitamin sources.

21. The method of any of claims 17-20, further comprising combining one or more sweetness enhancers.

22. The composition of any of claims 5-9, further comprising UTH extract.

23. The method of any of claims 17-21, wherein the composition has a brix value of less than about 12.

24. The composition of any of claims 1-4, wherein the composition has a brix value of less than about 12.

25. The composition of any of claims 5-16, wherein the composition has a brix value of less than about 12.

26. A composition comprising:
(1) 10-20% by weight, cranberry juice;
(2) sucrose;
(3) fructose;
(4) tara gum;
(5) UTH extract; and
(6) water,
wherein the ratio of sucrose: fructose: tara gum is about 45 to about 55: about 45 to about 55: about 1 to 5, respectively by weight, and wherein the composition has a brix value of 8 to 10, has 90 calories per 8 ounce serving, has 25 to 60 milligrams of proanthocyanidins per 8 ounce serving, and is free of artificial sweeteners.

27. A composition comprising:
(1) sucrose;
(2) fructose;
(3) a hydrocolloid; and
(4) water,
wherein the ratio of sucrose: fructose: hydrocolloid is about 45 to about 55: about 45 to about 55: about 1 to 5, respectively by weight.

28. A method of making a composition comprising combining:
(1) sucrose;
(2) fructose;
(3) tara gum; and
(4) water,
wherein the ratio of sucrose: fructose: pectin is about 45 to about 55: about 45 to about 55: about 1 to 5, respectively by weight.
